(19) United States
(12) Patent Application Publication
(10) Pub. No.: US 2010/0280139 A1
(43) Pub. Date: Nov. 4, 2010

(54) Sprayable elastomeric polyurethane foam and process for its production

(75) Inventors: Ronald A. Cageao, Beaver, PA (US); Merle W. Lesko, McDonald, PA (US)

Correspondence Address: BAYER MATERIAL SCIENCE LLC, 100 BAYER ROAD, PITTSBURGH, PA, 15205, US

(73) Assignee: Bayer MaterialScience LLC, Pittsburgh, PA (US)

(21) Appl. No.: 12/433,165

(22) Filed: Apr. 30, 2009

(51) Int. Cl. C08J 9/30

(52) U.S. Cl. 521/78

(57) ABSTRACT

The present invention relates to a sprayable elastomeric polyurethane foam made from the reaction product of at least one isocyanate, at least one isocyanate-reactive component and water, optionally in the presence of at least one of blowing agents, surfactants, cross-linking agents, extending agents, pigments, flame retardants, catalysts and fillers, wherein the sprayable elastomeric polyurethane foam has a free rise density of from about 5 lb/ft³ to about 25 lb/ft³, a reactive cream time of from about 10 seconds to about 120 seconds, and an elongation of from about 30% to about 300%.

### FIELD OF THE INVENTION

The present invention relates in general to polyurethane, and more specifically, to a sprayable elastomeric polyurethane foam which is suitable for use in the production of multilayer composites.

### BACKGROUND OF THE INVENTION

U.S. Pat. No. 4,241,129 issued to Marton et al., describes a multilayer, metal/organic polymer composite which is said to exhibit excellent resistance to delamination after thermoforming. The composite is produced by metallizing a substrate layer of thermoplastic organic polymer such as polystyrene or polycarbonate film and bonding the exposed metal surface to a structural plastic with a soft adhesive layer. Subsequently, the multilayer composite or at least a portion thereof can be shaped into an article which may be structurally reinforced by casting an elastomeric or rigid foamed polymer such as polyurethane foam into a cavity defined by the composite. The multilayer composites are useful in the manufacture of reflective and decorative parts for automobiles and other vehicles of transportation, as well as high barrier packages for foods and electroconductive elements.

Cenegy, in U.S. Pat. No. 4,507,336, provides a method for protecting a substrate, such as a roofing substrate by coating it with a low density polyurethane foam which is subsequently coated with an essentially non-porous, dense, elastomeric polyurethane layer. The layer is formed by spraying a volatile-free spray of polyurethane precursor reactants onto the surface of the foam and rapidly reacting the precursors.

U.S. Pat. No. 4,694,589 issued to Sullivan et al., relates a shoe-innersole material for use in providing cushioning and support in footwear, and a method of manufacturing the shoe-innersole material. The shoe innersole is made of a heel and an arch section composed of a molded, elastomeric polyurethane foam material of low compression set, the heel and arch sections directly bonded in the molding process to a full-sole material composed either of foam or a solid, flexible sheet material.

Harrison, et al., in U.S. Pat. No. 6,432,543, describe a sprayable elastomer composition for forming decorative components having an elastomeric outer surface. The aromatic polyurethane elastomers are said to be particularly suited for methods of making objects in a mold cavity. The objects generally include an elastomeric layer formed from an aromatic polyurethane and a foam layer which is subsequently applied to the elastomer. The aromatic elastomer is said to lend itself to being precoated with an in-mold coating or being painted after demolding the resulting part.

U.S. Pat. No. 6,884,507 issued to Lin, et al. provides tough, high modulus, low density thermoset polyurethane compositions which are said to be useful in cast structural materials and in a preferred embodiment can be cured directly onto an aircraft engine fan blade, thereby providing a lighter blade, without concomitant loss in structural integrity or blade performance due to resistance to foreign object impacts and fuel efficiency. In a preferred embodiment, the composition is comprised of bis-amine compounds reacted with isocyanate-functional polyether polymers in the presence of hollow polymeric microspheres. The thermoset polymer compositions are formed by casting into a mold which is formed by a cavity within the metallic or composite fan blade or guide vane in the form of a pocket and a removable caul sheet. After the elastomeric polyurethane foam is injected through at least one injector port into the mold, the foam is cured.

A need continues to exist in the art for sprayable elastomeric polyurethane foams suitable for use in the production of multilayer composites.

### SUMMARY OF THE INVENTION

Accordingly, the present invention provides a sprayable elastomeric polyurethane foam made from the reaction product of at least one isocyanate, at least one isocyanate-reactive component and water, optionally in the presence of at least one of blowing agents, surfactants, cross-linking agents, extending agents, pigments, flame retardants, catalysts and fillers, wherein the sprayable elastomeric polyurethane foam has a free rise density of from about 5 lb/ft³ to about 25 lb/ft³, a reactive cream time of from about 10 seconds to about 120 seconds, and an elongation of from about 30% to about 300%.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a sprayable elastomeric polyurethane foam made from the reaction product of at least one isocyanate, at least one isocyanate-reactive component and water, optionally in the presence of at least one of blowing agents, surfactants, cross-linking agents, extending agents, pigments, flame retardants, catalysts and fillers, wherein the sprayable elastomeric polyurethane foam has a free rise density of from 5 lb/ft³ to 25 lb/ft³, a reactive cream time of from 10 seconds to 120 seconds, and an elongation of from 30% to 300%.

The present invention also provides a process for producing a sprayable elastomeric polyurethane foam involving reacting at least one isocyanate, at least one isocyanate-reactive component and water, optionally in the presence of at least one of blowing agents, surfactants, cross-linking agents, extending agents, pigments, flame retardants, catalysts and fillers, wherein the sprayable elastomeric polyurethane foam has a free rise density of from 5 lb/ft³ to 25 lb/ft³, a reactive cream time of from 10 seconds to 120 seconds, and an elongation of from 30% to 300%.

The inventive sprayable elastomeric polyurethane foam contains at least one polyisocyanate. Suitable polyisocyanates are known to those skilled in the art and include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula

Q(NCO)ₙ

in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (“TDI”); diphenylmethane-2,4′- and/or -4,4′-diisocyanate (“MDI”); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI or polymeric MDI, PMDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

In general, it is preferred to use readily available polyisocyanates, such as 2,4- and 2,6-toluene diisocyanates and mixtures of these isomers (TDI); polyphenyl-polymethylene-polyisocyanates of the type obtained by condensing aniline with formaldehyde, followed by phosgenation (crude MDI or polymeric MDI, PMDI); and polyisocyanates containing carbodiimide groups, urethane groups, allophanate groups, isocyanurate groups, urea groups, or biuret groups (modified polyisocyanates).

Isocyanate-terminated prepolymers may also be useful in the preparation of the sprayable elastomeric polyurethane foams of the present invention. Prepolymers may be prepared by reacting an excess of organic polyisocyanate or mixtures thereof with a minor amount of an active hydrogen-containing compound as determined by the well-known Zerewitinoff test, as described by Kohler in Journal of the American Chemical Society, 49, 3181 (1927). These compounds and their methods of preparation are well known to those skilled in the art. The use of any one specific active hydrogen compound is not critical; any such compound can be employed in the practice of the present invention. Preferred isocyanates for use in the present invention include MDI based materials and may either be monomeric, polymeric, or prepolymers.

Although any isocyanate-reactive compound may be used to produce the sprayable elastomeric polyurethane foam of the present invention, polyether polyols are preferred as isocyanate-reactive components. Suitable methods for preparing polyether polyols are known and are described, for example, in EP-A 283 148, U.S. Pat. Nos. 3,278,457; 3,427,256; 3,829,505; 4,472,560; 3,278,458; 3,427,334; 3,941,849; 4,721,818; 3,278,459; 3,427,335; and 4,355,188.

Suitable polyether polyols may be used such as those resulting from the polymerization of a polyhydric alcohol and an alkylene oxide. Examples of such alcohols include ethylene glycol, propylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, glycerol, 1,1,1-trimethylolpropane, 1,1,1-trimethylolethane, or 1,2,6-hexanetriol. Any suitable alkylene oxide may be used such as ethylene oxide, propylene oxide, butylene oxide, amylene oxide, and mixtures of these oxides. Polyoxyalkylene polyether polyols may be prepared from other starting materials such as tetrahydrofuran and alkylene oxide-tetrahydrofuran mixtures, epihalohydrins such as epichlorohydrin, as well as aralkylene oxides such as styrene oxide. The polyoxyalkylene polyether polyols may have either primary or secondary hydroxyl groups. Included among the polyether polyols are polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides. The polyoxyalkylene polyether polyols may be prepared by any known process.

As catalysts for polyurethane formation, it is possible to use those compounds which accelerate the reaction of the isocyanate with the isocyanate-reactive component. Suitable catalysts for use in the present invention include tertiary amines and/or organometallic compounds. Examples of compounds include the following: triethylenediamine, aminoalkyl- and/or aminophenyl-imidazoles, e.g. 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole, tin(II) salts of organic carboxylic acids, examples being tin(II) diacetate, tin(II) dioctoate, tin(II) diethylhexoate, and tin(II) dilaurate, and dialkyltin(IV) salts of organic carboxylic acids, examples being dibutyltin diacetate, dibutyltin dilaurate, dibutyltin maleate and dioctyltin diacetate.

The polyurethane forming reaction may take place, if desired, in the presence of auxiliaries and/or additives, such as cell regulators, release agents, pigments, surface-active compounds and/or stabilizers to counter oxidative, thermal or microbial degradation or aging.

The inventive sprayable elastomeric polyurethane foam preferably has a peel strength greater than 2 lb/in². The free-rise density of the inventive sprayable elastomeric polyurethane foam is from 5 to 25 lb/ft³, more preferably from 10 to 20 lb/ft³. The sprayable elastomeric polyurethane foam of the present invention preferably has an elongation of from 30 to 300%, more preferably from 75 to 250% and most preferably from 100 to 200%. The elongation of the inventive sprayable elastomeric polyurethane foam may range between any combination of these values, inclusive of the recited values. The sprayable elastomeric polyurethane foam preferably has a cream time (the time from initial mixing to change in appearance) of from 10 to 120 seconds, more preferably from 15 to 90 seconds and most preferably from 20 to 60 seconds. The cream time of the inventive sprayable elastomeric polyurethane foam may range between any combination of these values, inclusive of the recited values. The molded density of the inventive sprayable elastomeric polyurethane foam is from 25 to 65 lb/ft³, more preferably from 35 to 65 lb/ft³, and most preferably from 45 to 65 lb/ft³. The molded density of the inventive sprayable elastomeric polyurethane foam my range between any combination of these values, inclusive of the recited values.

### EXAMPLES

The present invention is further illustrated, but is not to be limited, by the following examples. All quantities given in “parts” and “percents” are understood to be by weight, unless otherwise indicated. By “isocyanate index” is meant the quotient of the number of isocyanate groups divided by the number of isocyanate-reactive groups, multiplied by 100. The following materials were used in producing the semi-rigid polyurethane foams of the examples:

| | |
|---|---|
| POLYOL A | a 4,800-molecular weight polyoxypropylene triol |
| | modified with ethylene oxide; having a functionality |
| | of about 3, a hydroxyl number of about 35 mg |
| | KOH/g; |
| POLYOL B | a glycerin-initiated polyoxyalkylene polyether triol |
| | having a hydroxyl number of 28 mg KOH/g; |
| POLYOL C | a 4,000 molecular weight propylene oxide/ethylene |
| | oxide polyether polyol based on PG, (80 wt. % |
| | PO/20 wt. % EO end block), having a hydroxyl |
| | number of about 28 mg KOH/g and a functionality |
| | of about 1.82; |
| CHAIN | ethylene glycol; |
| EXTENDER | |
| SURFACTANT | a polyalkylene oxide methyl siloxane copolymer |
| | from Momentive Performance Materials as NIAX |
| | L-1000; |
| CATALYST A | bis[2-dimethylaminoethyl]ether available from |
| | Momentive Performance Materials as NIAX A-1; |
| CATALYST B | triethylene diamine in dipropylene glycol (33/67) |
| | available from Air Products & Chemicals as |
| | DABCO 33LV; |
| CROSS LINKER | triethanolamine; and |
| ISOCYANATE | an isocyanate prepolymer having an NCO group |
| | content of about 23%, a viscosity of between about |
| | 500 and about 800 mPa · s at 25° C. and comprising |
| | the reaction product of about 86.8% by weight of |
| | 4,4′-diphenylmethane diisocyanate having an NCO |
| | content of about 33.6%, a functionality of about 2.0 |
| | and a viscosity of less than about 25 mPa · s at |
| | 25° C. and about 13.2% by weight of tripropylene |
| | glycol. |

The polyol system and isocyanate were combined in the lab to determine initial process information. Reactivity times and free rise density values were obtained by utilizing a high speed shear mixer to homogenize the components.

TABLE I

| | Ex. 1 | Ex. 2 | Ex. 3 |
|---|---|---|---|
| Component | | | |
| POLYOL A | 76.0 | 38.0 | 53.65 |
| POLYOL B | — | 38.0 | — |
| POLYOL C | 12.0 | 12.0 | 24.0 |
| CHAIN EXTENDER | 9.90 | 9.8 | 20.0 |
| CROSS LINKER | 0.30 | 0.3 | 0.3 |
| SURFACTANT | 1.0 | 1.0 | 1.0 |
| CATALYST A | 0.15 | 0.15 | 0.15 |
| CATALYST B | 0.50 | 0.50 | 0.50 |
| Water | 0.15 | 0.25 | 0.40 |
| ISOCYANATE | 77 | 78 | 144 |
| INDEX | 105 | 105 | 105 |
| Physical properties | | | |
| Free Rise Density (lb/ft³) | 25 | 18 | 15 |
| Molded Density (lb/ft³) | 58 | 50 | 50 |
| Tensile Strength (lb/in²) | 1450 | 1100 | 1650 |
| Elongation (%) | 150 | 250 | 75 |

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A sprayable elastomeric polyurethane foam comprising the reaction product of:
at least one isocyanate;
at least one isocyanate-reactive component; and
water,
optionally in the presence of at least one of blowing agents, surfactants, cross-linking agents, extending agents, pigments, flame retardants, catalysts and fillers,
wherein the sprayable elastomeric polyurethane foam has a free rise density of from about 5 lb/ft³ to about 25 lb/ft³, a reactive cream time of from about 10 seconds to about 120 seconds, and an elongation of from about 30% to about 300%.

2. The sprayable elastomeric polyurethane foam according to claim 1, wherein the at least one isocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethyl-cyclohexane (isophorone diisocyanate), 2,4- and 2,6-hexahydrotoluene diisocyanate, dicyclohexylmethane-4,4′-diisocyanate, 1,3- and 1,4-phenylene diisocyanate, 2,4- and 2,6-toluene diisocyanate, diphenylmethane-2,4′- and/or -4,4′-diisocyanate, polymeric diphenylmethane diisocyanate, naphthylene-1,5-diisocyanate, triphenyl-methane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates, isocyanate-terminated prepolymers and mixtures thereof.

3. The sprayable elastomeric polyurethane foam according to claim 1, wherein the at least one isocyanate-reactive component is selected from polyoxyalkylene polyether polyols having primary or secondary hydroxyl groups.

4. The sprayable elastomeric polyurethane foam according to claim 1, wherein the free rise density is from about 10 lb/ft³ to about 20 lb/ft³.

5. The sprayable elastomeric polyurethane foam according to claim 1, wherein the reactive cream time is from about 15 seconds to about 90 seconds.

6. The sprayable elastomeric polyurethane foam according to claim 1, wherein the elongation is from about 75% to about 250%.

7. A process for producing a sprayable elastomeric polyurethane foam comprising reacting:
at least one isocyanate;
at least one isocyanate-reactive component; and
water,
optionally in the presence of at least one of blowing agents, surfactants, cross-linking agents, extending agents, pigments, flame retardants, catalysts and fillers,
wherein the sprayable elastomeric polyurethane foam has a free rise density of from about 5 lb/ft³ to about 25 lb/ft³, a reactive cream time of from about 10 seconds to about 120 seconds, and an elongation of from about 30% to about 300%.

8. The process according to claim 7, wherein the at least one isocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3- and -1,4-diisocyanate, 1-isocyanato-3,3,5-trimethyl-5-isocyanatomethyl-cyclohexane (isophorone diisocyanate), 2,4- and 2,6-hexahydrotoluene diisocyanate, dicyclohexylmethane-4,4′-diisocyanate, 1,3- and 1,4-phenylene diisocyanate, 2,4- and 2,6-toluene diisocyanate, diphenylmethane-2,4′- and/or -4,4′-diisocyanate, polymeric diphenylmethane diisocyanate, naphthylene-1,5-diisocyanate, triphenyl-methane-4,4′,4″-triisocyanate, polyphenyl-polymethylene-polyisocyanates, norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates, isocyanate-terminated prepolymers and mixtures thereof.

9. The process according to claim 7, wherein the at least one isocyanate-reactive component is selected from polyoxyalkylene polyether polyols having primary or secondary hydroxyl groups.

10. The process according to claim 7, wherein the free rise density is from about 10 lb/ft³ to about 20 lb/ft³.

11. The process according to claim 7, wherein the reactive cream time is from about 15 seconds to about 90 seconds.

12. The process according to claim 7, wherein the elongation is from about 75% to about 250%.
